(19) United States
(12) Patent Application Publication
(10) Pub. No.: US 2006/0179078 A1
(43) Pub. Date: Aug. 10, 2006

(54) Multi-party playlist control including wireless enablement

(75) Inventor: James G. McLean, Fuquay-Varina, NC (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 11/051,818

(22) Filed: Feb. 4, 2005

(51) Int. Cl. G06F 17/00

(52) U.S. Cl. 707/104.1; 707/102

(57) ABSTRACT

A method and system for controlling one or more user playlists in a digital media communications system. A media control unit that stores or has access to digital media content detects the presence of one or more users of the digital media communications system. The media control unit obtains a playlist containing preferred multimedia selections from each user and stores each playlist. A universal playlist is then constructed where the universal playlist incorporates the preferred media selections form each participating user's playlist. Media selections are then played or made available to the users of the system from the universal playlist.

### BACKGROUND OF THE INVENTION

1. Statement of the Technical Field

The present invention relates to the field of digital audio and multimedia systems and more particularly to a method and system for accessing, combining and prioritizing users' audio and multimedia preferences to provide an optimal playlist that incorporates the preferences of all registered users.

2. Description of the Related Art

The multimedia industry is in the middle of a dynamic and revolutionary era. Gone are the days when the only means to access a favorite song, album or movie was to purchase it at a local record or video store. Now, via the use of the Internet, or interactive television and satellite connections, users can obtain virtually any song or movie they wish. As additional digital multimedia formats are created, storage media capacity has increased, and compression techniques have improved, allowing musical and video selections to become more and more portable in terms of digitally stored files. An example of this is the exploding popularity of MP3 files and streaming audio and video technologies, which allow entire musical and video selections to be accessed, stored, traded and played back digitally.

The transmission of digital multimedia directly to listeners is increasing in popularity. Current digital satellite television systems include thirty or more channels of digital music and/or video as part of a basic subscription package. The direction appears to be headed toward the random-access of virtually any musical or video selection ever recorded, whether via the Internet, satellite or other technologies. Further, local digital repositories of multimedia selections may be present in a home, mobile, or office environment. Such “media servers” may contain many multimedia selections representing the media collections of multiple family members, co-workers, roommates, or friends. A shared media server may serve entire dormitories, apartment buildings, or other communities

When a user logs onto a digital multimedia access service or accesses a local media server or multimedia repository, he or she can choose a movie or video clip, or select a song or specific musical genre and the service can accommodate them by playing or transmitting for playback the video or song listed on the user's playlist. Various personalized playlist strategies allow the user to customize the selection of songs or videos that they would like to be played. In these instances, the service, or local server, can play the songs on the user's playlist, and/or offer to transmit them to the user for download. Of note, as used herein, the term “songs” includes both audio-only as well as multimedia.

However, there are many instances when more than one user is logged onto the service at the same time, or is listening to or viewing selections from the local entertainment server or multimedia repository. In these simultaneous-access scenarios, more than one listener or viewer can be logged into the service and each listener or viewer may provide their own playlist of selections that they wish to have played. Alternatively, the service or local server may have access to a pre-defined playlist associated with each listener or viewer.

Because digital music and video providers typically provide media selections on a random-basis, in the multi-user situation, at least one user may have to wait an extended period of time and listen to a number of consecutive songs or videos that are not on their playlist but are on other users' playlists. Moreover, a present listener or viewer may have to endure selections from another present listener or viewer's playlist that are not acceptable or preferable to them. Depending upon the number of simultaneous users, this might result in the passage of a significant amount of time before a selection from the user's list is played.

It is therefore desirable to have a digital audio and multimedia distribution system and method which detects the presence of one or more users, receives or retrieves each user's preferred playlists, and constructs a universal playlist of media selections that incorporates the individual preferences for each user.

### SUMMARY OF THE INVENTION

The present invention addresses the deficiencies in the art with respect to multiple-user playlist control and provides a novel and non-obvious method, system and apparatus for constructing a playlist of multimedia selections that incorporates the individual preferences for each user logged into a digital multimedia distribution system. In this fashion, a universal playlist of media selections can be created by taking into account the personalized preferences from each currently-logged on user. The creation of a universal multi-party playlist results in the playing of media selections that are a cross-sectional mix of each user's playlist.

According to one aspect, the present invention provides a method of creating a universal playlist from one or more user playlists corresponding to one or more users in a digital media communication system. The presence of one or more users wishing to access digital media content in the digital media communication system is detected and each user's playlist is accessed. Each user playlist includes one or more media selections. A universal playlist is then constructed that incorporates the media selections of each user's playlist. The media selections from the universal playlist are then retrieved and transmitted to the one or more users.

According to another aspect, the present invention provides a system for creating a universal playlist from one or more user playlists corresponding to one or more users in a digital media communication system. The system includes a media control unit in communication with the one or more users in the digital communication system. The media control unit includes a storage unit that stores digital media content and the playlists of the one or more users. The media control unit also includes a processing unit in communication with the storage unit. The processing unit operates to perform the functions of detecting the presence of one or more users wishing to access digital media content and constructing a universal playlist based upon the media selections of each user's playlist.

According to still another aspect, a machine readable storage device having stored thereon a computer program for creating a universal playlist from one or more user playlists corresponding to one or more users in a digital media communication system is provided. The computer program includes a set of instructions which when executed by a machine causes the machine to perform a method that includes detecting the presence of one or more users wishing to access digital media content, accessing each user's playlist, where each user's playlist includes one or more media selections, constructing a universal playlist incorporating the media selections of each user's playlist, and transmitting media selections from the universal playlist to the one or more users.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of the specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a diagram of an exemplary system constructed in accordance with the principles of the present invention;

FIG. 2 is a diagram of an exemplary system constructed in accordance with the principles of the present invention illustrating the construction of a universal playlist;

FIG. 3 is a flow chart illustrating the overall process of an embodiment of the present invention;

FIG. 4 is a flow chart illustrating an alternate embodiment of the present invention; and

FIG. 5 is a flow chart illustrating yet another embodiment of the present invention.

### DETAILED DESCRIPTION OF THE PREFERRED EMBODIMENTS

An apparatus for detecting the presence of multiple users of a digital multimedia communications system, accessing the individual selection playlists of each user, and creating a universal playlist that is representative of the combined preferences of the users. This technique takes into account media selections that appear on multiple playlists, prevents multiple selections from being played that only appear on one playlist and incorporates specific user criteria such as preferences based upon a particular time of day, and preferences based upon the time elapsed since a particular selection was played. As used herein, the term “media” refers to audio content only as well as all multimedia such as video. Further, the term “selection” refers to all multimedia such as songs or video.

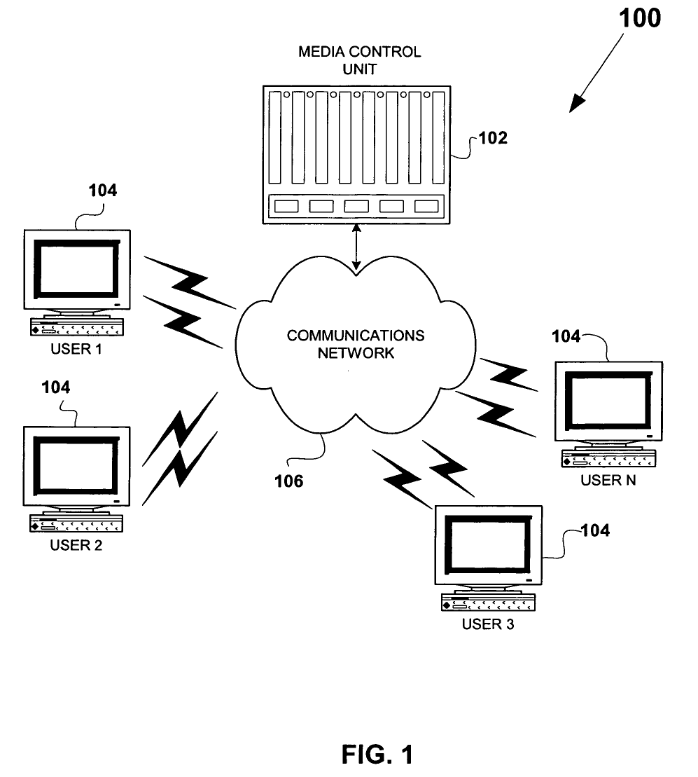

Referring now to the drawing figures in which like reference designators refer to like elements there is shown in FIG. 1 a system constructed in accordance with the principles of the present invention and designated generally as “100”. System 100 includes an entertainment media control unit 102 that stores digital media selections and one or more users 104 that can access control unit 102. Media control unit 102 can be any media source that is capable of storing and providing access to digital media selections, such as audio and/or video content. Alternately, unit 102 may be a conduit between a remote digital media storage device and users 104. Media control unit 102 also contains memory and data storage capacity sufficient to store user identification information including playlists, and a processor capable of preparing a universal playlist representative of each user's individualized playlist.

Media control unit 102 can include a storage unit such as volatile or non-volatile memory, a processing unit, input and output devices, network interface hardware, display units and the like, controlled by application software programs. The storage unit stores digital audio content and the playlists of one or more users. The storage unit may receive the playlists either directly from the users or receive the playlists from a remote playlist repository. The processing unit, which is in communication with the storage unit, operates to perform the functions of detecting the presence of one or more users wishing to access digital audio content and constructing a universal playlist based upon the media selections of each user's playlist.

The participating users 104 can access the digital media selections stored in media control unit 102 over a telecommunications network 106 via a wide range of traditional communication schema. For example, the users 104 can log onto the Internet and initiate communication with unit 102 in order to obtain streaming audio, or video, or subscribe to a digital satellite television program that allows the users 102 to access a large amount of digital media. Users 104 can also download media selections from the Internet onto their digital multimedia receiver via a wireless connection.

Media control unit 102 can also be a stationary or portable media storage server that is typically used in the home or at public locations such as offices, restaurants, or night clubs. Thus, because users 104 are in close proximity to unit 102, they may listen to musical selections or view video selections from unit 102 without having to access a formal communications network such as the Internet, or obtain an RF connection in order to download media files or receive streaming audio or video content from unit 102. Instead, users 104 transmit their respective playlists to unit 102 either by manually entering the information on unit 102 or transmitting the playlists to unit 102 by traditional electronic means, i.e., a wireless transmission from the user's audio player. Thus, communications network 106 as shown in FIG. 1 may also represent the medium by which audio and/or video signals are transmitted by unit 102 directly to local users 104 in the form of musical and video selections.

Media control unit 102 stores digital media content (or is in communication with a data storage unit that contains the digital media content) via traditional multimedia data compression methods. For example, digital media content may be stored in MP3, WMA, or WAV formats. Users having the appropriate software on their terminals have access to a tremendous library of available digital multimedia content. Users can select specific songs or videos and media control unit 102, upon receipt of a user's request, may transmit the songs or videos to the requesting computer. It should be noted that unit 102 can be an entertainment unit capable of storing digital media such as a stationary or mobile audio or video player. In this scenario, where users are in proximity to the digital audio/video player, the step of “transmitting digital media” to the users represents the actual “playing” of the audio or video selection rather than “transmission” of the digital media content to the user.

The present invention allows media control unit 102 to detect the presence of users 104 via a number of techniques. One example of detecting the presence of users 104 is via a manual input. Each user may manually enter either their name or their identification number and transmit this information to unit 102. A user may be presented with an icon or button on their computer, telephone, television, or digital audio or video player prompting the user to indicate their presence by selecting the icon or button. Another way for the user to indicate their presence manually is via a microphone. The user can speak their name into the microphone and voice recognition software stored in or in communication with unit 102 in connection with a database of stored voice messages allows for the voice identification of the user.

In another embodiment, media control unit 102 determines the presence of one or more users 104 by automatically sensing which users 104 are currently “logged onto” the system and in communication with media control unit 102. For example, unit 102 can determine which users 104 are present by transmitting a series of radio-frequency waves. Users with radio frequency identification devices (RFID) containing key fobs send RF identification information back to unit 102. In this fashion, unit 102 can compile a list of users that wish to access digital media selections from unit 102. Alternately, users that carry Bluetooth-enabled devices such as Bluetooth cellular telephone or personal data assistants can communicate directly with unit 102 and “log on” to the system. It is within the spirit of the invention to include any user identification system that allows users 104 to communicate with unit 102 and provide individualized identification in order for unit 102 to recognize the presence of one or more users 104. Media control unit 102 thus determines, either manually, or automatically, the users 104 that are simultaneously accessing the communications network 106 and wish to access digital media files from unit 102.

The next step is for unit 102 to obtain each user's playlist. A playlist is a listing of musical or video selections that a user wishes to hear or download. Typically, a user lists the selections in their order of preference, i.e., the song or video the user most wishes to hear or download is listed first, followed by their second favorite, and so on. A user 104 can send his or her playlist to media control unit 102 and unit 102 plays the song or video on the user's playlist in order, or presents the songs or videos on the playlist for available download. Media control unit 102 can also be configured to retrieve a pre-stored playlist corresponding to each user 104. The present invention addresses the scenario when more than one user is simultaneously logged onto the system and each user wishes to hear, view or download media from their respective playlists.

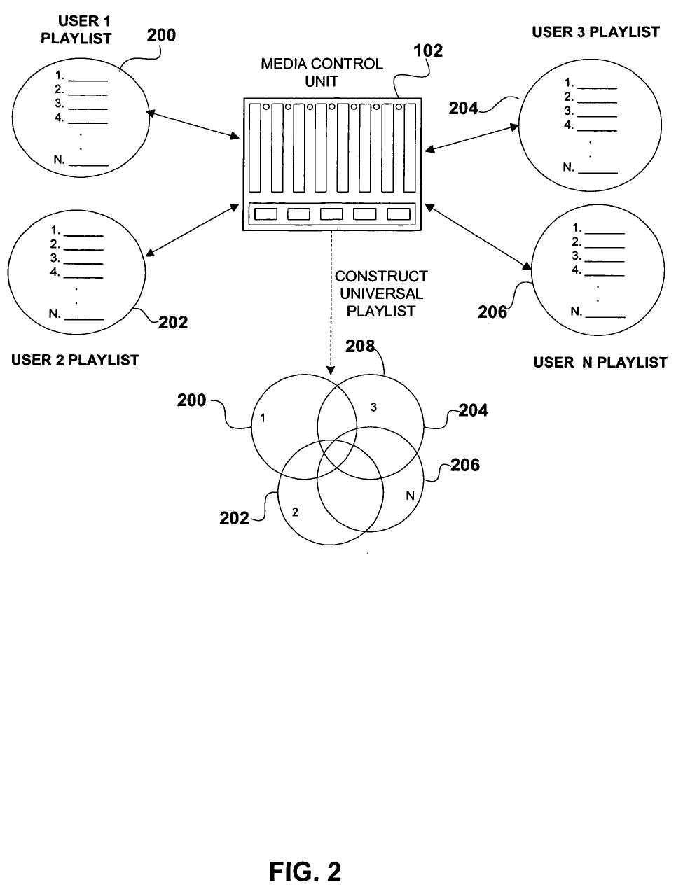

FIG. 2 depicts unit 102 in communication with four users 104. Although only four users are shown in FIG. 2, the present invention is adaptable to any number (n) of users 104. As described above, each user 104 prepares a playlist that represents the musical or video selections that the user would like to hear or view, or be made available for download. For example, user 1 prepares playlist 200, user 2 prepares playlist 202, user 3 prepares playlist 204, and user N prepares playlist 206. Media unit 102 detects the presence of users 1 through N by one or more of the methods discussed above. Each user then transmits their individualized playlist to unit 102, where they are stored separately. Media unit 102 then constructs a universal playlist 208 that is representative of all the users currently logged onto the system.

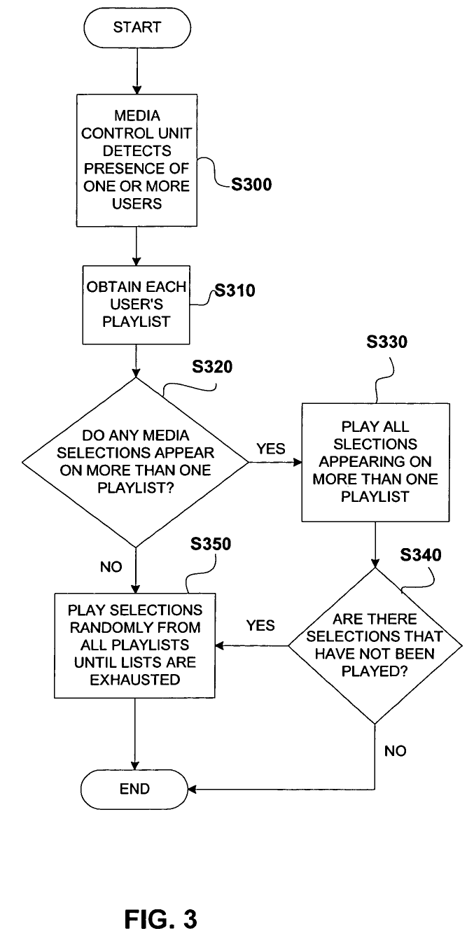

FIG. 3 is a flow chart illustrating an embodiment of the present invention and particularly illustrates a method of constructing a universal playlist that incorporates the media selection preferences of more than one user. Media control unit 102 detects the presence of users 104 that wish to access the digital content stored in unit 102 (or stored remotely) (step S300), by receiving user identification information and confirming the identity of the user. As described above, this verification process could be via one of any well known techniques such as voice identification, manual input by the user, or via an automatic sensing technique. After the number of users and the identity of each user 104 have been determined, each user 104 transmits his or her playlist to unit 102 (step S310). Media control unit 102 stores playlists from each user, by gathering playlists either directly from each user or from a remote playlist repository (not shown). Each playlist is stored under its respective user name in a user file created during step S300.

Media unit 102 then prepares a universal playlist that takes into account the media selections of each of the stored playlists. In one scenario, media unit 102 first examines the stored playlists and determines if any media selections on the user playlists appear on more than one playlist (step S320). If there are media selections that appear on more than one playlist, these selections are flagged and will be played prior to the selections that appear on only one playlist. Unit 102 may further prioritize the order in which the selections will be played by determining which selections appear most on the playlists. For example, if the song “Born To Run” by Bruce Springsteen appears on four playlists, “Twist and Shout” by the Beatles appears on three playlists and “Goodbye Pork Pie Hat” by Charles Mingus appears on only two playlists, the universal playlist created by unit 102 will list songs beginning with “Born To Run”, since this selection appears most frequently in the users' playlists. “Twist and Shout” will appear second on the universal playlist, followed by “Goodbye Pork Pie Hat”. The playlist may then playback “Born to Run” as its first song, followed by the next most frequent listing, “Twist and Shout”, followed by “Goodbye Pork Pie Hat”. Finally, songs and/or video appearing on only one playlist may be played randomly or according to other playback criteria discussed below. Once such mutually-acceptable playlists are defined, the playback order may be randomized to effectively mix the most-demanded songs over time.

Once unit 102 has queried each of the user's individual playlists and has created a universal playlist based on the most popular selections, unit 102 plays the selections according to one of several pre-determined playback criteria (step S330). For example, as shown in FIG. 3, unit 102 may play the songs appearing most frequently first, according to their popularity as described in the above example. After these selections have been played, all remaining selections (i.e., songs appearing on the playlists only once) are played randomly (steps S340 and S350) until all the songs have been played. If desired, the process may then be repeated.

Alternately, unit 102 may play the songs appearing a greater number of times, proportionally, according to the number of appearances of that song in all of the playlists. For example, if the total number of songs on all of the playlists total 40, using the above example, unit 102 would play a total of forty musical selections with “Born To Run” being played eight times, “Brown Sugar” played six times, “Goodbye Yellow Brick Road” played four times, and every other song played twice, totaling forty songs. Thus, the songs appearing most frequently on the users' playlists are played the most and in proportion to their respective appearances on the users' playlists.

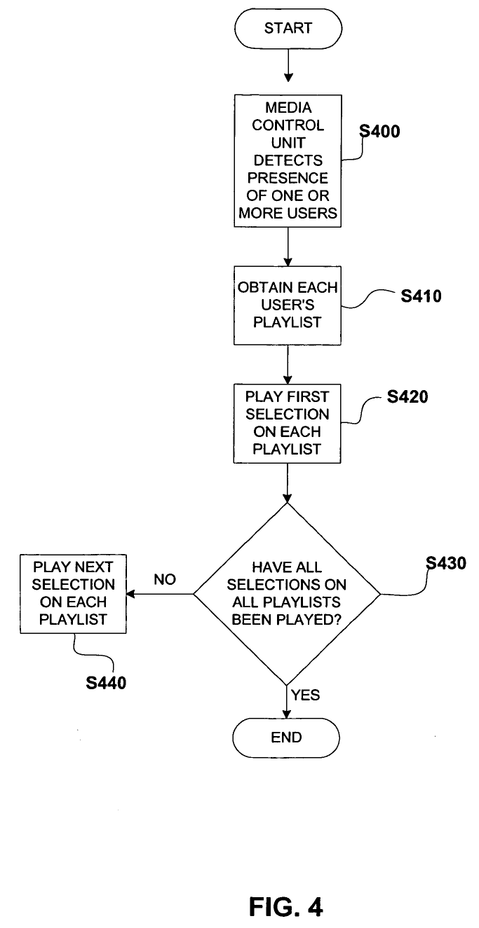

FIG. 4 illustrates an alternate embodiment, in which unit 102 selects media from each user playlist in an alternating manner. Once again, unit 102 obtains user playlists either directly from each user or from a remote playlist repository that receives playlists directly from the users. Unit 102 detects the presence of one or more users (step S400) and accesses each playlist (step S410). Instead of unit 102 determining which media selections appear most frequently on the stored user playlists, unit 102 randomly selects one user playlist, plays a selection from this playlist, plays a song or video from a next randomly-chosen user playlist and continues until one song or video from each playlist has been played (step S420). Unit 102 determines if all media selections from all of the playlists have been played (step S430), and if not, plays the next song or video on each playlist (step S440). Once all of the media selections from the playlists have been played, the process ends, or the process can be repeated. In this scenario, each user hears a song or views a video (or is presented either for download) from their playlist without system 100 skipping selections from their playlist to repeatedly play selections from other playlists.

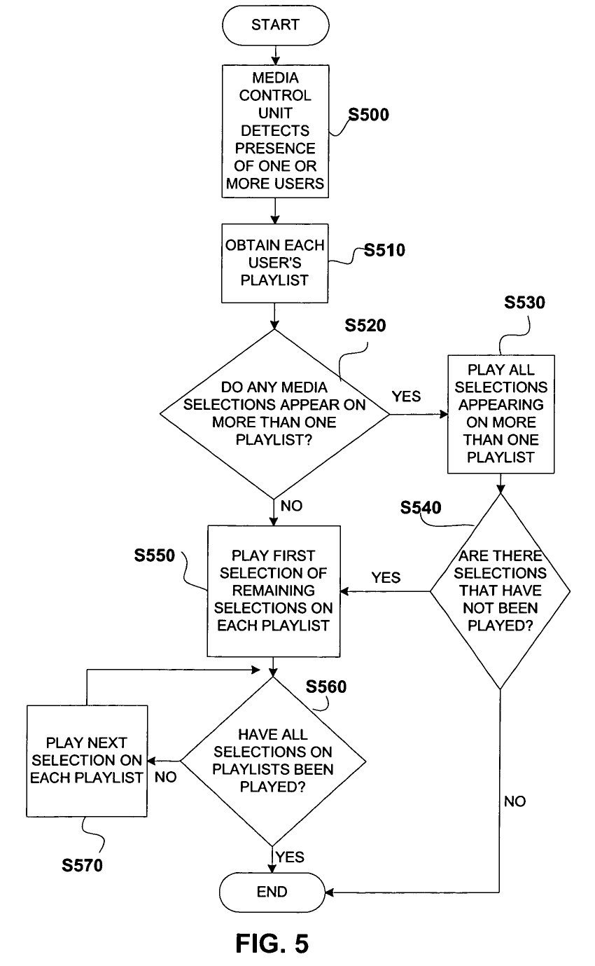

FIG. 5 illustrates yet another embodiment of the invention. After unit 102 detects the presence of users 104 (step S500) and receives each user playlist (step S510) (either directly or from a playlist repository), unit 102 determines if any media selections appear on more than one playlist and how frequently each reoccurring song ore video selection appears (step S520), similar to the process described in step S320 in FIG. 3. The selections appearing on more than one playlist may be played first (step S530), until these selections are exhausted (step S540), and the remaining selections that appear only once on a playlist may be played. However, instead of playing these remaining selections randomly, as in step S350 (FIG. 3), the remaining selections are played according to the criteria illustrated in steps S420 and S430 of FIG. 4. Thus, after unit 102 plays the most frequently listed selections, the first non-played selection is played from each playlist (step S550), and the sequential process continues until all of the selections from all playlists have been played (steps S560 and S570).

The present invention is not limited to the playback strategies listed above and illustrated in the figures and may utilize other playback schemes to provide a universal playlist that encompasses each user playlist. In addition to each user providing a playlist indicating that user's media preferences, each user could provide additional media preference criteria including preferences based upon a particular time of the day, preference of a particular musical genre or artist, or preferences based upon the amount of time elapsed since the playing of a particular song or video. For example, if a user is at work during the day he or she may not want a particular genre of song or video played from their playlist during those hours. The user can supply this preference information to unit 102 along with their playlists. Therefore, unit 102 will not play the song or video during the time period indicated.

Users 104 may also prefer not to hear a song or view a video on their playlist more than once within a specified time period. Thus, if a song or video is played from a user's playlist and the user does not want to hear or view a second playing of the selection for six hours, unit 102 will “strike” the selection from the user's playlist for the indicated time, and recalculate its selection criteria resulting in a modification of the universal playlist. After the specified time period has elapsed, the song or video is re-inserted and a new universal playlist is constructed with the previously deleted selection now incorporated. Other user preference information may be transmitted to unit 102 for use in constructing a universal playlist including preference of musical genre (i.e., jazz, funk, classical, country, etc.), video genre (i.e. drama, comedy, documentary, etc.) preference of a particular artist, or restrictions on the playing of consecutive songs from one artist or off a particular album.

Users 104 may also prefer never to be exposed to a particular selection, artist, genre or style. Thus, while playlists may typically list selections that a user 104 prefers above other selections, the user may also include selections that they do not wish to listen to or view. For example, a user may never want to listen to a disco song or a song by EMINEM, or prefer never to view a Quentin Tarantino film. Unit 102 will thus “strike” such a “negative” selections from the universal playlist while that user is present. Thus, in addition to affirmative preferences, the universal playlist that is constructed also incorporates each user's negative selections, i.e. selections that the user never wants to hear or see.

The present invention is not limited to particular media selection preference criteria and can advantageously construct a universal playlist based upon each user's individual preference criteria. The present invention advantageously considers each present user's current playlist and preferences and constructs a universal playlist that can be constantly modified depending upon the number of users present. For instance, if a current user logs off the system, unit 102 detects this and the particular user's playlist is no longer considered. A new universal playlist is constructed with a new “pool” of multimedia selections and preferences, and songs or videos are played or made available for download according to the currently selected playback criteria.

Once again, the invention is equally adaptable to an environment where users 104 are not local and in close proximity (i.e. listening and/or viewing distance) to unit 102) and an environment where the users 104 may listen or view media selections directly from local unit 102. In the former scenario, users 104 may “log on” to a communications network 106 and access media selections stored in unit 102 via the Internet, satellite television, wireless RF communication techniques or the like. In this scenario, users 104 may transmit their respective playlists and receive media selections based upon the constructed universal playlist via the communications network 106. In the latter scenario, users 104, after having submitted their playlists, may listen to or view media selections directly from unit 102, which plays the selections based upon the universal playlist constructed.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

I claim:

1. A method of creating a universal playlist from one or more user playlists corresponding to one or more users in a digital media communication system, the method comprising:
detecting the presence of one or more users wishing to access digital media content in the digital media communication system;
accessing each user's playlist, each user's playlist comprising one or more media selections;
constructing a universal playlist incorporating the media selections of each user's playlist; and
transmitting media selections from the universal playlist to the one or more users.

2. The method of claim 1, wherein constructing a universal playlist includes:
determining if one or more media selections appear on more than one user playlist; and
if one or more media selections appear on more than one user playlist,
transmitting the one or more media selections appearing on more than one user playlist before media selections that appear on only one playlist.

3. The method of claim 2, wherein the media selections that appear on only one playlist are randomly transmitted.

4. The method of claim 2, wherein transmitting the media selections that appear on only one playlist includes transmitting one media selection sequentially from each playlist until all the media selections that appear on only one playlist have been transmitted.

5. The method of claim 1, further comprising accessing each user's media selection preferences, wherein constructing a universal playlist incorporates the media selections of each user's playlist and each user's media selection preferences.

6. The method of claim 5, wherein the media selection preferences includes one or more of requesting a media selection to be played at a particular time of the day, requesting a media selection not be played, and requesting that a media selection be played only after a specified period of time has elapsed since the playing of the media selection.

7. The method of claim 1, wherein detecting the presence of one or more users wishing to access the digital media content in a digital media communication system includes automatically sensing the presence of the one or more users.

8. The method of claim 1, wherein detecting the presence of one or more users wishing to access the digital media content in a digital media communication system includes the one or more users manually indicating their presence.

9. A system for creating a universal playlist from one or more user playlists corresponding to one or more users in a digital media communication system, the system comprising:
a media control unit in communication with the one or more users in the digital communication system, the media control unit comprising:
a storage unit storing digital media content and the playlists of the one or more users; and
a processing unit in communication with the storage unit, the processing unit operating to perform the functions of detecting the presence of one or more users wishing to access digital media content and constructing a universal playlist based upon the media selections of each user's playlist.

10. The system of claim 9, wherein the processing unit constructs a universal playlist by further performing functions including:
determining if one or more media selections appear on more than one user playlist; and
if one or more media selections appear on more than one user playlist, transmitted the one or more media selections appearing on more than one user playlist before media selections that appear on only one playlist.

11. The system of claim 10, wherein the media selections that appear on only one playlist are randomly transmitted.

12. The system of claim 11, wherein transmitting the media selections that appear on only one playlist includes transmitting one media selection sequentially from each playlist until all the media selections that appear on only one playlist have been transmitted.

13. The system of claim 9, wherein the processing unit further performs functions including accessing each user's media selection preferences, wherein constructing a universal playlist incorporates the media selections of each user's playlist and each user's media selection preferences.

14. The system of claim 13, wherein the media selection preferences includes one or more of requesting a media selection to be played at a particular time of the day, requesting a media selection not be played, and requesting that a media selection be played only after a specified period of time has elapsed since the playing of the media selection.

15. The system of claim 9, wherein detecting the presence of one or more users wishing to access the digital media content includes automatically sensing the presence of the one or more users.

16. The system of claim 9, wherein detecting the presence of one or more users wishing to access the digital media content in a digital media communication system includes the one or more users manually indicating their presence.

17. A machine readable storage device having stored thereon a computer program for creating a universal playlist from one or more user playlists corresponding to one or more users in a digital media communication system, the computer program comprising a set of instructions which when executed by a machine causes the machine to perform a method including:
detecting the presence of one or more users wishing to access digital media content in the digital media communication system;
accessing each user's playlist, each user's playlist comprising one or more media selections;
constructing a universal playlist incorporating the media selections of each user's playlist; and
transmitting media selections from the universal playlist to the one or more users.

18. The machine readable storage device of claim 17, wherein constructing a universal playlist includes:
determining if one or more media selections appear on more than one user playlist; and
if one or more media selections appear on more than one user playlist,
transmitting the one or more media selections appearing on more than one user playlist before media selections that appear on only one playlist.

19. The machine readable storage device of claim 18, wherein transmitting the media selections that appear on only one playlist includes transmitting one media selection sequentially from each playlist until all the media selections that appear on only one playlist have been transmitted.

20. The machine readable storage device of claim 17, the method performed by the machine further comprising accessing each user's media selection preferences, wherein constructing a universal playlist incorporates the media selections of each user's playlist and each user's media selection preferences.

21. The machine readable storage device of claim 20, wherein the media selection preferences includes one or more of requesting a media selection to be played at a particular time of the day, requesting a media selection not be played and requesting that a media selection be played only after a specified period of time has elapsed since the playing of the media selection.

22. The machine readable storage device of claim 17, wherein detecting the presence of one or more users wishing to access the digital media content in a digital media communication system includes automatically sensing the presence of the one or more users.

23. The machine readable storage device of claim 17, wherein detecting the presence of one or more users wishing to access the digital media content in a digital media communication system includes the one or more users manually indicating their presence.
